(19) United States
(12) Patent Application Publication
(10) Pub. No.: US 2002/0139846 A1
(43) Pub. Date: Oct. 3, 2002

(54) Method and system for handheld shopping assistant

(76) Inventors: Bradford H. Needham, North Plains, OR (US); Linda S. Needham, North Plains, OR (US)

Correspondence Address: PILLSBURY WINTHROP, LLP, P.O. BOX 10500, MCLEAN, VA, 22102, US

(21) Appl. No.: 09/818,992

(22) Filed: Mar. 28, 2001

(51) Int. Cl. G06K 15/00

(52) U.S. Cl. 235/383

(57) ABSTRACT

A method and system for a handheld recommendation assistant are presented. Product information of a product is read from a product tag by a handheld device. Consumer information is retrieved through a connection to a consumer information storage device. The consumer information is associated with the product and is retrieved based on the product information. Personal information of the user that is relevant to at least one aspect of the product is also acquired. Accordingly, a product recommendation is generated based on the personal information and the consumer information.

### BACKGROUND

1. Field

The present invention relates to electronic commerce (e-commerce). Specifically, the invention relates to systems and methods that make product recommendations.

2. General Background and Related Art

The rapid development of the Internet has stimulated significant growth in electronic commerce. More and more products may be browsed and purchased over Internet connections. This new form of shopping offers some advantages over conventional store shopping.

Based on specific personal requirements, an Internet shopper can rapidly search for products across a wide range of product providers. In addition, an online shopper can compare prices charged by different providers—often, all on one screen—before a product choice is made. In conventional store shopping, time and geographical constraints make it difficult for a shopper to browse products from a wide range of product providers in a reasonable amount of time. Comparing prices in a conventional shopping scenario often requires the shopper to make individual price inquiries about each of the products to be compared.

However, online shopping does have some disadvantages. Online shoppers often see only a small number of products retrieved based on a query chosen by the shopper (e.g., show all personal computers within the price range $1,000 to $2,000). The number of choices an online shopper can see is also limited by the size of the displaying screen. By contrast, a conventional shopper may walk around a shopping mall and see a large variety of products. Even though a shopper may enter a mall with specific products in mind, the shopper may decide to stop at various shops to browse other products. He or she may ultimately make a purchase that was not originally planned.

In some ways, conventional store shoppers may decide what is desirable more easily than online shoppers. Indeed, conventional store shopping adds a personal touch to the shopping experience. However, if a product having features that a shopper desires is not available in a store, it may be difficult for the shopper to quickly and conveniently locate sources where the desired product can be found. For example, if a shopper likes a coat seen in a store, but the store does not have the shopper's particular size, the shopper has to give up or wait until the store can locate a coat of the same style in the correct size.

Therefore, what is needed is a system and method that provides a conventional store shopper with both the capabilities of an online shopper and the advantages of a conventional store shopper.

### BRIEF DESCRIPTION OF THE DRAWINGS

FIG. 1 is a high-level diagram of a system according to the present invention.

FIG. 2 is a block diagram of a handheld device according to an embodiment of the present invention.

FIG. 3 is a flowchart showing a method according to the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for a handheld recommendation assistant, as described herein, involves reading product information from a product tag by a handheld device. Based on the product information, consumer information associated with the product is retrieved through a connection to a consumer information storage device. Personal information of a user that is relevant to at least one aspect of the product is acquired. Accordingly, a product recommendation is generated based on the personal information and the consumer information.

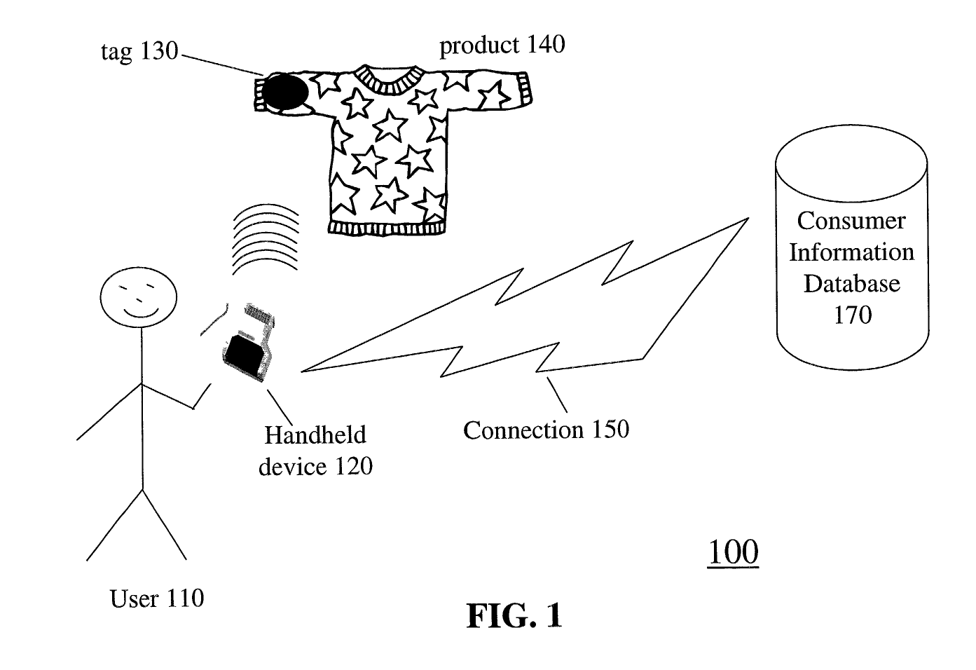

FIG. 1 is a high-level diagram of system 100 according to the present invention. System 100 comprises handheld device 120, consumer information database 170, and tag 130 attached to product 140.

Tag 130 may be a machine-readable product tag containing encoded information relating to product 140. For instance, tag 130 may comprise a conventional bar code. In an exemplary implementation, tag 130 may comprise a radio frequency identification (RFID) tag. An RFID tag may allow a reader to read the tag at a relatively short distance, and with reasonably high accuracy. Moreover, an RFID tag may store more information than conventional bar code labels. Tag 130 may convey a host of identifying information, such as information relating to product 140. For instance, tag 130 may convey manufacturer, style, size, color, fabric, ingredients, store number and location, and other such specifications of product 140.

Handheld device 120 may be held and operated by a user 110, who may be a patron in a store. Handheld device 120 may read tag 130 via a scanner (not shown) incorporated within handheld device 120. As such, handheld device 120 may decode and process product information associated with product 140 and conveyed by tag 130. For users with disabilities, handheld device 120 may be configured to be attached to a personal transportation vehicle, such as a wheelchair.

Handheld device 120 communicates with consumer information database 170 via connection 150. Connection 150 may comprise a local or remote connection. Consumer information database 170 may contain consumer information relating to various products, such as product 140. Consumer information database 170 may reside in local or remote locations. For instance, consumer information database 170 may be stored within handheld device 120, may be accessible to handheld device 120 via a network connection, such as a wireless Internet connection to a Web server, or may be stored within a shopping mall server accessible to handheld device 120 over a local area network. In some embodiments, encrypted information may be exchanged between handheld device 120 and consumer information database 170.

Consumer information database 170 may include a host of information about product 140 that is more detailed than information about product 140 conveyed by tag 130. Consumer information database 170 may be stored in a volatile or nonvolatile memory, such as a hard disk, CD-ROM, or optical disk. Additionally, consumer information database 170 may include a recommendation processor (not shown) that makes recommendations and transmits them back to handheld device 120.

In some embodiments, consumer information database 170 may include personal information of user 110 provided to consumer information database 170 by user 110 via handheld device 120. User 110 may also provide personal information to consumer information database 170 during a Web session that user 110 initiated from a client computer at some earlier date.

In other embodiments, consumer information database 170 may comprise a database containing product information associated with products of a limited number of manufacturers. As such, handheld device 120 may communicate with multiple consumer information databases over respective connections in order to retrieve consumer information sought by user 110.

Handheld device 120 may receive personal information associated with user 110. Handheld device 120 may compare personal information provided by user 110 with information retrieved from consumer information database 170. As such, handheld device 120 may provide a product recommendation for user 110.

For instance, handheld device 120 may read tag 130 on a sweater in a store, decode the information conveyed by tag 130, and thus acquire manufacturer, style, and size information for the sweater. Using that general product information as an index, handheld device 120 may access consumer information database 170 to retrieve more detailed information relating to the sweater, such as tailored measurements for the sweater. Handheld device 120 may compare the tailored measurements with measurements of user 110, which user 110 may have previously inputted into handheld device 120. Accordingly, handheld device 120 may recommend to user 110 that user 110 select size “small” for this particular sweater.

In other embodiments, handheld device 120 may scan tag 130 attached to a shirt. Along with the manufacturer and style of the shirt, handheld device may transmit favorite colors of user 110 inputted by user 110 to consumer information database 170. Consumer information database 170 may transmit to handheld device 120 the shirt manufacturer's recommendations for matching trousers, socks, and shoes based on the favorite colors of user 110. Accordingly, system 100 of FIG. 1 may provide “personal shopper” service for user 110 without the need for a salesperson.

In a grocery store, tag 130 on a can of soup may encode a list of the soup ingredients. Handheld device 120 may identify the ingredients, compare the ingredients with prerecorded food allergies or dietary restrictions of user 110, and may inform user 110 whether this variety of soup is appropriate for user 110. Handheld device 120 may also access consumer information database 170 to receive a personalized recommendation of other foods that user 110 may purchase to prepare a balanced, tasteful meal. In such an embodiment, handheld device 120 may simply present a recommendation forwarded by consumer information database 170.

In another situation, user 110 may like a particular product, but a store may not have the size worn by user 110 in stock. Handheld device 120 may scan tag 130 attached to the product. Handheld device 120 may receive recommendations from consumer information database 170 as to alternative sources for the product in the size worn by user 110, such as, for example, other nearby stores or Web retailers. Handheld device 120 may allow user 110 to issue a request to consumer information database 170, which may request that the product be shipped to the store, or that the product be shipped directly to the residence of user 110, with instructions to debit an account of user 110.

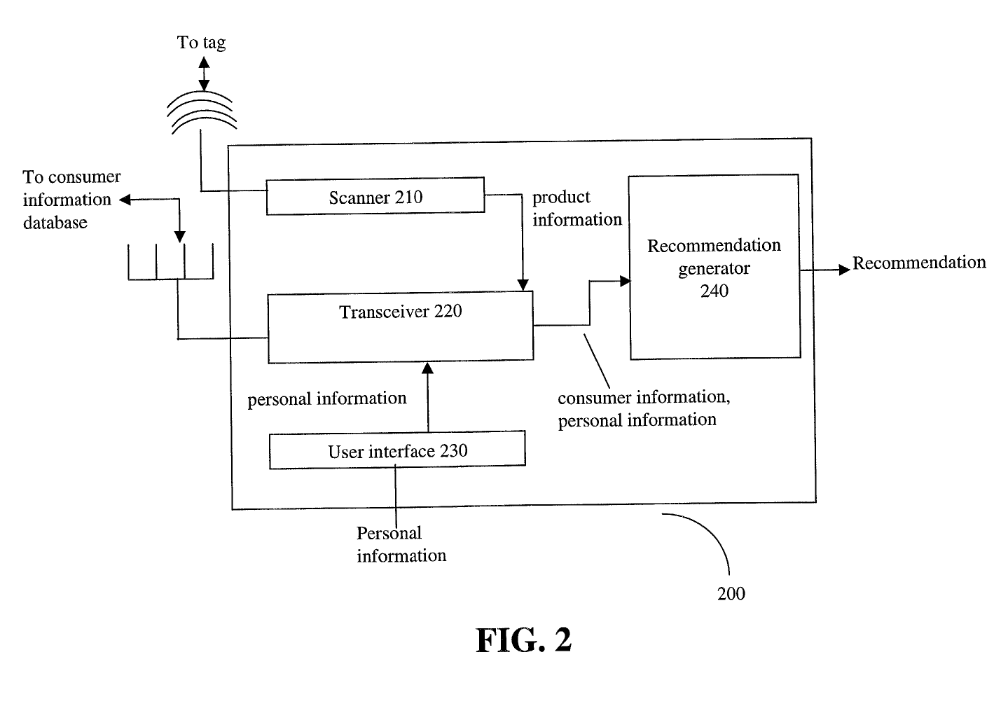

FIG. 2 is a block diagram of handheld device 200 according to an embodiment of the present invention. Handheld device 200 comprises scanner 210, transceiver 220, user interface 230, and recommendation generator 240. Scanner 210 reads product information recorded on a tag. User interface 230 enables a user to input personal information into handheld device 200, such as a product cost preference. Such personal information may be stored in handheld device 200. In other embodiments, personal information may be downloaded from another source, such as a personal computer or the Internet.

Transceiver 220 receives product information and personal information from scanner 210 and user interface 230, respectively. Transceiver 220 may also transmit information to consumer information database 170, and receive information therefrom. In an exemplary implementation, transceiver 220 transmits product information to consumer information database 170, and receives associated consumer information from consumer information database 170.

Recommendation generator 240 receives consumer information and personal information from transceiver 220. Recommendation generator 240 may compare consumer information with personal information, and may thereby produce a comparison result. Based on the comparison result, recommendation generator 240 may recommend a product to purchase. The recommendation may be based on consistency between the consumer information associated with available products and the personal information of user 110. It is to be noted that recommendation generator 240 may output a recommendation provided by consumer information database 170, and received by transceiver 220.

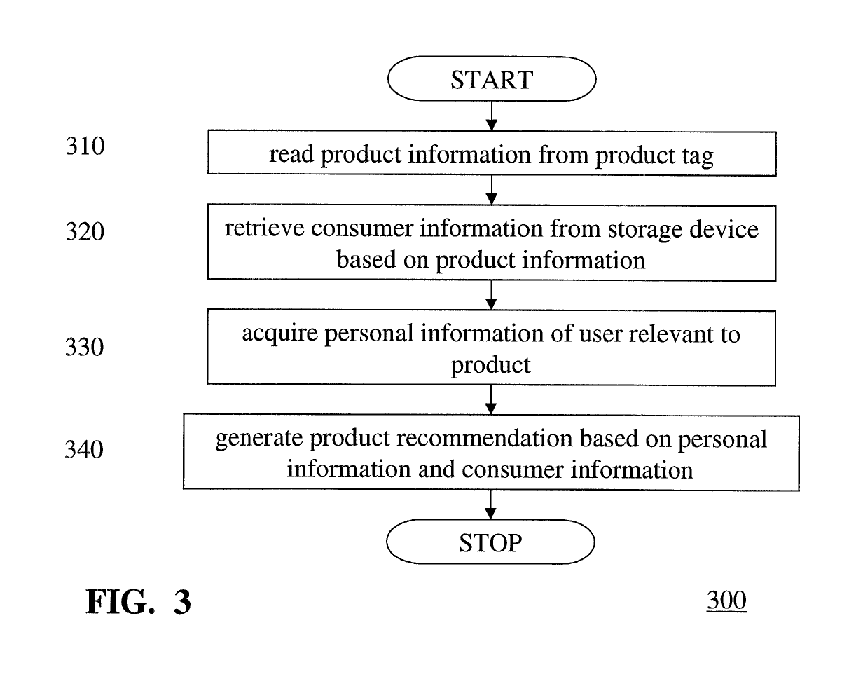

FIG. 3 is a flowchart showing method 300 according to the present invention. In item 310, the method reads product information from a product tag attached to a product. In item 320, consumer information is retrieved from a storage device based on the product information read from the product tag. Personal information of a user that is relevant to the product is acquired in item 330. The operations denoted in items 320 and 330 may be performed in parallel, in succession, or in reverse order. In item 340, a product recommendation is generated based on the personal information and consumer information.

The foregoing description of the preferred embodiments is provided to enable any person skilled in the art to make or use the present invention. Various modifications to these embodiments are possible, and the generic principles presented herein may be applied to other embodiments as well. For instance, a handheld device may support side-by-side comparisons. Specifically, a user may scan multiple products in a store. The handheld device may then generate recommendations in view of those products based on various system- or user-supplied criteria, such as fit, durability, cost, and the like.

Further, the handheld recommendation assistant described herein may be employed in broader settings than simply commercial establishments. For instance, a patron of a public library may scan a tag attached to a book to ascertain whether the patron is likely to enjoy the book based on the patron's favorite literary genres.

Moreover, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for a handheld recommendation assistant, said method comprising:
reading, by a handheld device, product information of a product from a product tag;
retrieving consumer information through a connection to a consumer information storage device, said consumer information being associated with said product and being retrieved based at least in part on said product information, said consumer information including information about said product;
acquiring personal information of a user relevant to at least one aspect of said product; and
generating a product recommendation related to said product based at least in part on said personal information and said consumer information.

2. The method according to claim 1, wherein said product information includes a product identifier.

3. The method according to claim 1, wherein said product information includes a list of the ingredients of a product.

4. The method according to claim 1, wherein said product information includes a product size specification.

5. The method according to claim 1, wherein said product tag includes a bar code tag.

6. The method according to claim 1, wherein said product tag includes an RFID tag attached to the product.

7. The method according to claim 1, wherein said handheld device is capable of communicating with said consumer information storage device and generating said product recommendation.

8. The method according to claim 1, wherein said consumer information includes information about an alternative source for said product.

9. The method according to claim 1, wherein said consumer information includes tailored measurements of a clothing product.

10. The method according to claim 1, wherein said connection includes a network connection.

11. The method according to claim 1, wherein said consumer information storage device includes a local database stored on a medium.

12. The method according to claim 1, wherein said consumer information storage device has access to a database of a remote server.

13. The method according to claim 1, wherein said acquiring personal information includes acquiring said personal information entered through an interface on said handheld device.

14. The method according to claim 1, wherein said acquiring personal information includes retrieving said personal information stored in said handheld device.

15. The method according to claim 1, wherein said personal information includes personal tailoring measurements.

16. The method according to claim 1, wherein said personal information includes a color preference.

17. The method according to claim 1, wherein said generating a product recommendation comprises:
comparing said personal information and said consumer information to produce a comparison result;
identifying, based at least in part on said comparison result, at least one recommended product whose consumer information is consistent with said personal information; and
recommending said at least one recommended product via said handheld device to said user.

18. The method according to claim 1, further comprising:
storing said product information, in a machine-readable form, in said product tag; and
attaching said product tag, containing said machine-readable product information, to said product.

19. A system for a handheld recommendation assistant, said system comprising:
a handheld device configured to read product information of a product from a product tag and to access data over one or more connections, said handheld device being further configured to acquire personal information of a user relevant to at least one aspect of said product and to generate a product recommendation related to said product; and
a consumer information storage device including consumer information, said consumer information being associated with said product and being retrievable by said handheld device, over said one or more connections, based at least in part on said product information,
wherein said product recommendation is based at least in part on said personal information and said consumer information.

20. The system according to claim 19, wherein said consumer information storage device has access to a database of a remote server.

21. A handheld recommendation assistant, said assistant comprising:
a scanner configured to read product information of a product from a product tag;
a transceiver configured to acquire personal information of a user relevant to at least one aspect of said product, said transceiver being further configured to retrieve consumer information from a consumer information storage device based at least in part on said product information, said consumer information being associated with said product; and
a recommendation generator configured to provide a product recommendation related to said product based at least in part on said personal information and said consumer information.

22. The assistant of claim 21, further comprising an interface configured to allow said user to input said personal information to said assistant.

23. The assistant of claim 21, wherein said product recommendation is determined by a remote server.

24. A computer-readable medium encoded with a plurality of processor-executable sequences for:
reading, by a handheld device, product information of a product from a product tag;
retrieving consumer information through a connection to a consumer information storage device, said consumer information being associated with said product and being retrieved based at least in part on said product information, said consumer information including information about said product;
acquiring personal information of a user relevant to at least one aspect of said product; and
generating a product recommendation related to said product based at least in part on said personal information and said consumer information.

25. The computer-readable medium according to claim 24, wherein said generating a product recommendation comprises:
comparing said personal information and said consumer information to produce a comparison result;
identifying, based at least in part on said comparison result, at least one recommended product whose consumer information is consistent with said personal information; and
recommending said at least one recommended product via said handheld device to said user.
